(19) United States
(12) Patent Application Publication
(10) Pub. No.: US 2011/0146492 A1
(43) Pub. Date: Jun. 23, 2011

(54) AIR SEPARATION MODULE FIBER MATERIAL FORMULATION

(75) Inventors: MELISSA DOPKINS, Chicago, IL (US); ADAM GLEN THOMAS, Chicago, IL (US); CHUNQING LIU, Schaumburg, IL (US); REHAN ZAKI, Naperville, IL (US)

(73) Assignee: HONEYWELL INTERNATIONAL INC., MORRISTOWN, NJ (US)

(21) Appl. No.: 12/641,787

(22) Filed: Dec. 18, 2009

(51) Int. Cl. B01D 53/22; B29C 47/00; C08K 5/092

(52) U.S. Cl. 96/10; 264/177.14; 524/321

(57) ABSTRACT

Hollow fiber membranes, such as those used in air separation modules, are generally made from solution spinning. Typically, solvent is present in the bore of the fiber for the spinning process. This solvent, in addition to the solvent already present in the polymer dope solution, may cause voids in the fiber material. By adding citric acid to the polymer dope material, these voids may be reduced or eliminated.

### BACKGROUND OF THE INVENTION

The present invention generally relates to air separation module (ASM) fiber material and methods for preparing ASM fiber material and, more particularly, to ASM fiber material formulated using citric acid in a polymer dope solution.

ASMs are a key component for the nitrogen generation systems (NGS) needed to provide fuel tank inerting for commercial and military aircraft. Useful membranes for separating oxygen from nitrogen must have sufficient selectivity to distinguish between these two similar gases, and must also have high flux. Hollow fiber membranes are often used as ASMs.

Hollow fiber membranes are generally made from solution spinning, which introduces a large amount of solvent into the middle “bore” of the hollow fiber. This high concentration of solvent, along with the solvent already present in the polymer dope solution, may yield large void spaces in the walls of the fiber. These void spaces may weaken the structure of the hollow fiber and lower the pressure rating of the fiber.

Referring to FIGS. 1 and 2, there are shown cross-sectional views of a hollow fiber membrane formed by conventional methods. A hollow fiber membrane 100 was prepared using a polymer dope solution consisting of solvents and non-solvents. The fiber membrane 100 was spun into a room temperature water bath and drawn onto a take-up roller.

Referring to FIGS. 3 and 4, there are shown cross-sectional views of a second hollow fiber membrane formed by conventional methods. A second hollow fiber membrane 105 was prepared using the same polyimide of FIGS. 1 and 2 in a polymer dope solution consisting of solvents and non-solvents. The fiber membrane 105 was spun into a room temperature water bath and drawn onto a take-up roller.

In both of these hollow fiber membranes 100, 105, void spaces 110 can be seen in the wall of the hollow fiber membranes 100, 105. As can be seen from comparing FIGS. 2 and 4, the frequency (per volume fiber) and size of these void spaces 110 may be variable between batches made of similar materials.

As can be seen, there is a need for a hollow fiber membrane formulation and methods for producing hollow fiber membranes that may reduce or eliminate the void spaces in the walls of the fibers.

### SUMMARY OF THE INVENTION

In one aspect of the present invention, a polymer dope solution comprises a solvent; a non-solvent; between about 0.5 to about 10 percent citric acid admixed in the solvent to give a citric acid solution; and a polymer dissolved in the citric acid solution, the polymer having a concentration between about 25 and about 30 percent by weight.

In another aspect of the present invention, a hollow fiber membrane is formed by solution spinning a polymer dope solution, wherein the polymer dope solution includes a solvent, a non-solvent, between about 0.5 to about 10 percent citric acid, and a polymer.

In a further aspect of the present invention, a method for preparing a hollow fiber membrane comprises adding citric acid to a solvent to form a citric acid solution; adding the citric solution to a polymer to give a polymer solution having a final polymer concentration of about 25 to about 30 weight percent; and spinning the polymer solution in a water bath to form a hollow fiber membrane.

These and other features, aspects and advantages of the present invention will become better understood with reference to the following drawings, description and claims.

### BRIEF DESCRIPTION OF THE DRAWINGS

FIG. 1 is a cross-sectional view of a hollow fiber membrane according to the prior art;

FIG. 2 is a close-up view of the comparative example of FIG. 1;

FIG. 3 is a cross-sectional view of a second hollow fiber membrane according to the prior art;

FIG. 4 is a close-up view of the comparative example of FIG. 3;

FIG. 5 is a cross-sectional view of a hollow fiber membrane according to an embodiment of the present invention;

FIG. 6 is a close-up view of the hollow fiber membrane of FIG. 5;

FIG. 7 is a cross-sectional view of a hollow fiber membrane according to another embodiment of the present invention;

FIG. 8 is a close-up view of the hollow fiber membrane of FIG. 7; and

FIG. 9 is a flow chart describing a method according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention provide an air separation module fiber material formulation and methods for making air separation module fiber modules. Hollow fiber membranes are generally made from solution spinning. Typically, solvent is present in the bore of the fiber for the spinning process. This solvent, in addition to the solvent already present in the polymer dope solution, may cause voids in the fiber material. By adding citric acid (3-hydroxypentanedioic acid-3-carboxylic acid) to the polymer dope material, according to an exemplary embodiment of the present invention, these voids may be reduced or eliminated.

Embodiments of the present invention may find beneficial use in industries such as the automotive, electricity generation and aerospace industries. Embodiments of the present invention may be beneficial in applications including manufacturing and repair of aerospace components. Embodiments of the present invention may be useful in applications including inerting fuel tanks and other compartments, such as cargo holds. Embodiments of the present invention may be useful in any gas separation application including, but not limited to, NGS.

Generally, the polymer dope solution includes a polymer or mixture of polymers, along with a solvent or solvents (i.e., N-methylpyrrolidone (NMP), tetrahydrofuran (THF), 1,3-dioxolane, and the like) and non-solvents (i.e., acetone, isopropanol and the like). The ratio of solvent to non-solvent is known in the art to have an effect on a wide variety of fiber properties, including fiber morphology.

Typical studies with conventional solvents and non-solvents, however, often do not take into account the relationship that an alkaline solvent, such as NMP, may have with an acidic non-solvent. According to an exemplary embodiment of the present invention and as further described by the below examples, citric acid may reduce or eliminate voids in the fiber membrane final product.

While not being limited to any particular theory, it has been observed that a polymer dope solution, including citric acid (typically less than about 10% citric acid), would solidify or coagulate almost instantly when exposed to water. This may occur due to the citric acid's affinity for water, and the fact that the acid had bound itself to the solvent NMP, thus drawing the solvent out of the polymer dope solution faster than previously seen when citric acid is not present in the polymer dope solution. The increased rate of solvent leeching may result in a fiber morphology that may have a uniform pore structure, and where the aforementioned void spaces may be reduced or eliminated.

The polymer used in the polymer dope solution may be, for example, polymers known in the art to form hollow fiber membranes. For example, polysulfones, poly(ether sulfones) and polyimides may be useful polymers to form hollow fiber membranes. For some embodiments, useful polymers may include polycarbonates, polyphenyl ethers, polyethers, aromatic polyamides, polycarbonates, polysilicones, polyetherimides, polyestercarbonates, copolymers incorporating these polymer types, and mixtures thereof. In an exemplary embodiment, the polyimide “A”, as shown prepared in the reaction scheme below, may be used in the present invention.

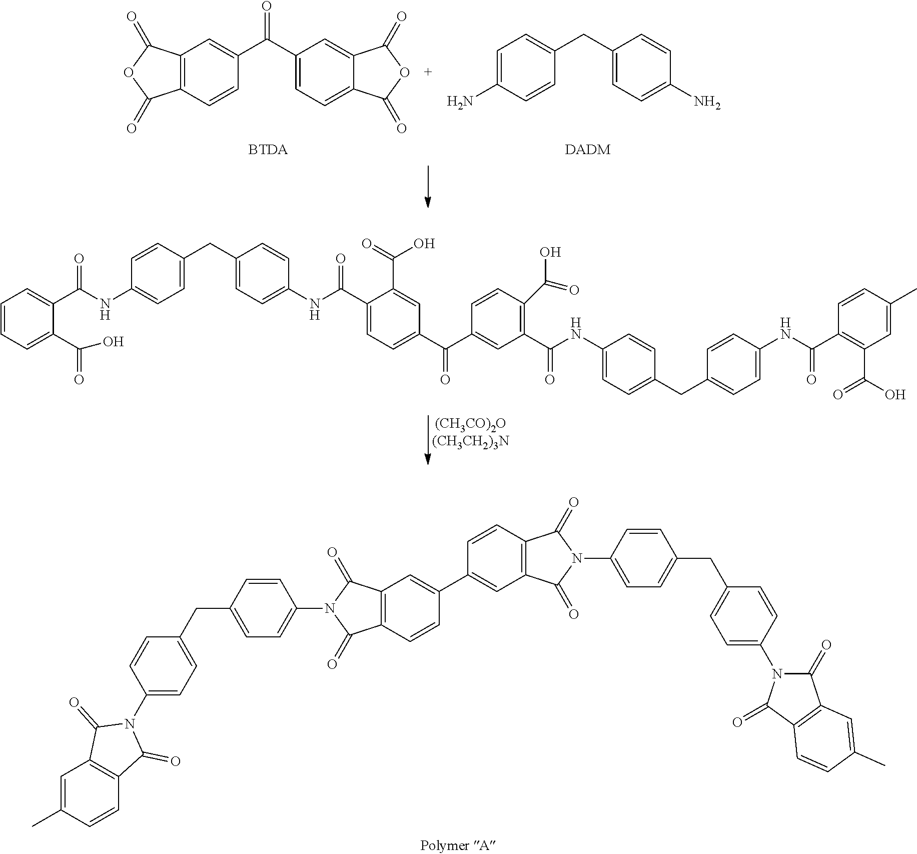

### EXAMPLES

### General Preparation A

### Polymer Dope Solution Formulation

The polymer dope solution, according to an exemplary embodiment of the present invention, may be prepared according to the following general preparation. To a solution of a basic solvent (such as NMP, dimethyl acetamide, N,N-dimethyl formamide, 1-formylpiperidine, and the like) and non-solvent (such as acetone or a C₁-C₆ alkanol, for example isopropanol (IPA), methanol, ethanol, n-propanol, or n-butanol) is added citric acid. The resulting solution is added dropwise to a polymer to give a solution that is between about 25 to about 30 percent by weight of the polymer. The resulting solution is mixed slowly with shear for about 4 hours at room temperature and allowed to degas (for example, by bubbling nitrogen gas therethrough) overnight before use.

The final solution, before addition of the polymer, typically contains from about 55 to about 85 weight percent solvent, from about 5 to about 30 weight percent non-solvent, and from about 0.5 to about 10% weight citric acid. In an exemplary embodiment of the present invention, the final solution contains from about 70 to about 80 weight percent solvent, from about 15 to about 25 weight percent non-solvent, and from about 4 to about 8 weight percent citric acid.

### General Preparation B—Formation of Polymer “A”

The synthesis of polymer “A” may involve two steps. In the first, the anhydride (in this case 3,3′,4,4′-benzophenone tetracarboxylic dianhydride (BTDA), and the diamine (in this case 4,4′-diaminodiphenyl-methane (DADM) are mixed at room temperature in an NMP solution. This produces the intermediate polyamic acid product. To complete polyimide preparation, a dehydrating agent, acetic anhydride, is added along with triethylamine to scrub the resulting acid, generating the final polyimide. This final step is done portionwise, and is accompanied by a significant increase in viscosity. Once further addition of acetic anhydride has no additional effect, the product is precipitated by removing it with a pipette and adding it to excess methanol.

### Example 1

A hollow fiber membrane was prepared using 26 weight percent polymer “A” in a polymer dope solution consisting of 81.0 weight percent NMP, 14.9 weight percent IPA and 4.1 weight percent citric acid. The fiber membrane was spun into a room temperature water bath and drawn onto a take-up roller.

### Example 2

A hollow fiber membrane was prepared using a 26 weight percent 80:20 mixture of polymer “A”: poly(ethersulfone) in a polymer dope solution consisting of 74.5 weight percent NMP, 19.4 weight percent IPA and 6.1 weight percent citric acid. The fiber membrane was spun into a room temperature water bath and drawn onto a take-up roller.

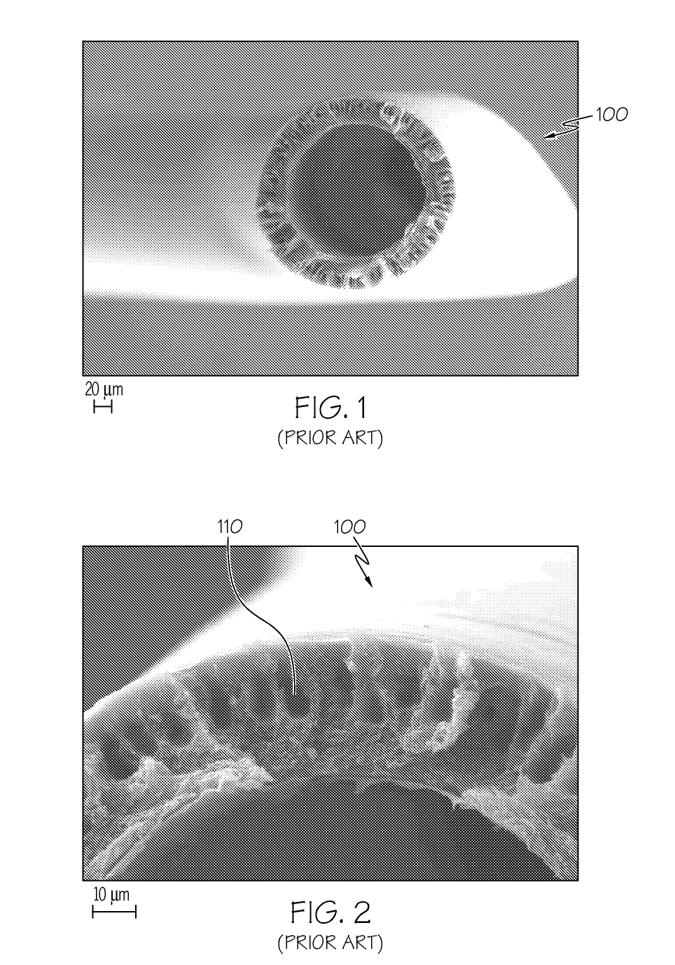

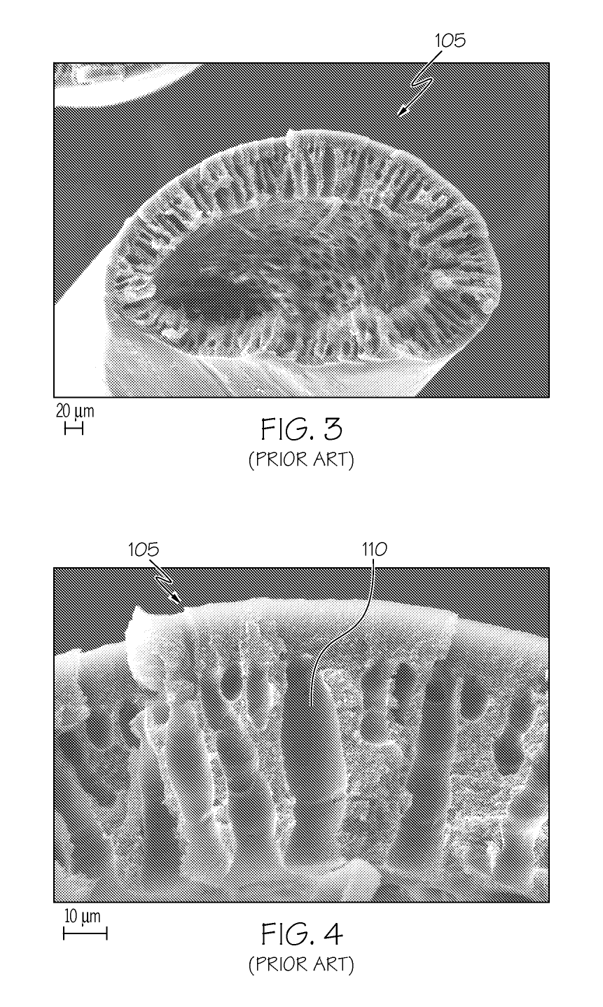

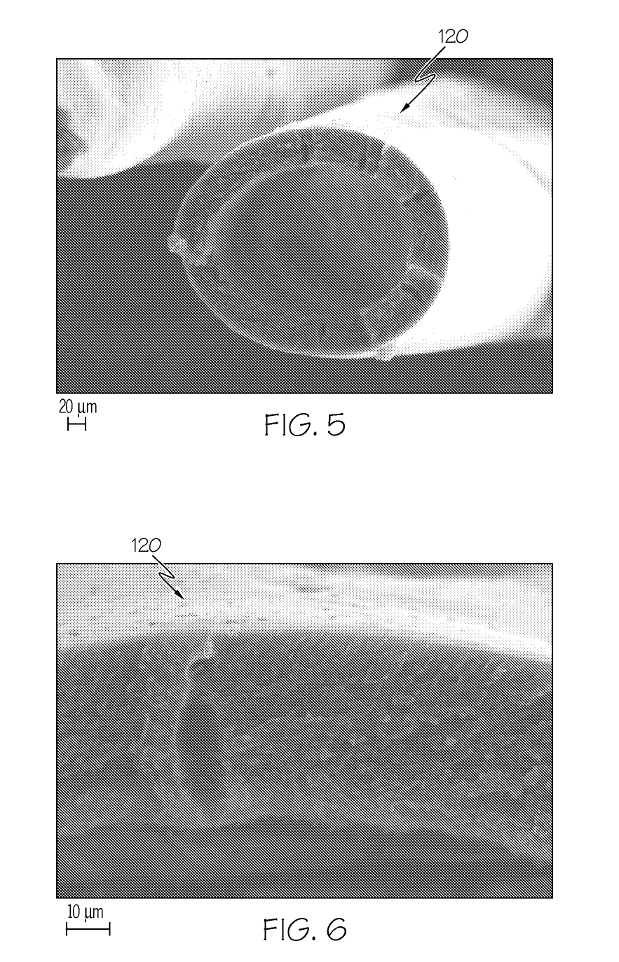

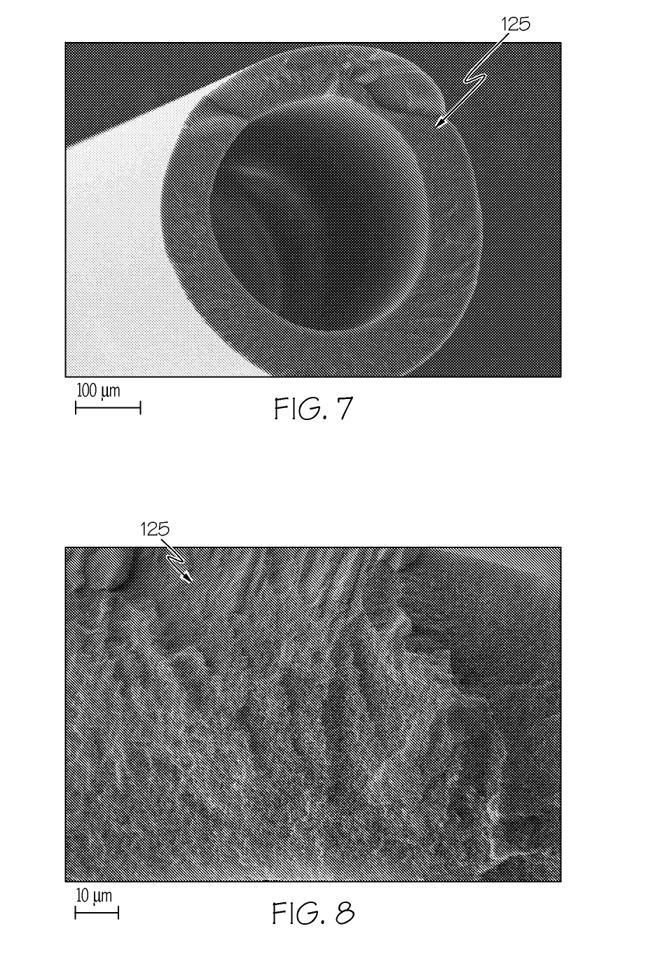

As can be seen from FIGS. 5-8, by using citric acid in the polymer dope solution formulation, voids, such as the void spaces 110 of FIGS. 1-4 were reduced or eliminated in the resulting hollow fiber membranes 120, 125.

### Methods

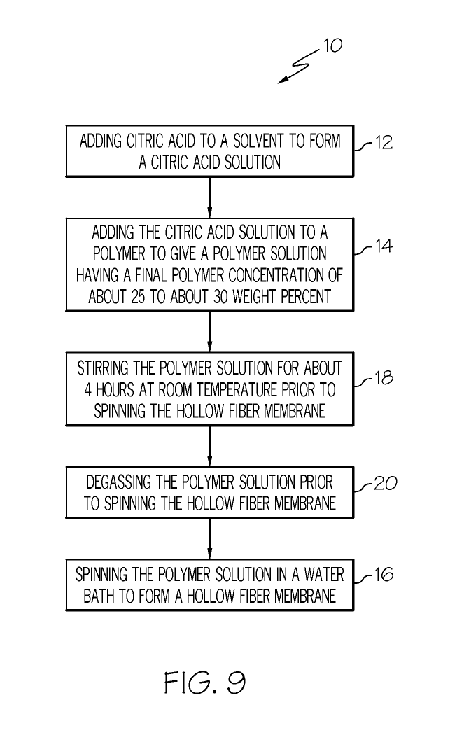

Referring now to FIG. 9, there is shown a flow chart describing a method 10 for preparing a hollow fiber membrane. The method 10 may include a step 12 of adding citric acid to a solvent to form a citric acid solution. In one embodiment of the present invention, the solvent may be NMP and the citric acid may be present from about 4 to about 10 percent of the resulting citric acid solution. The method 10 may include a further step 14 of adding the citric solution to a polymer to give a polymer solution having a final polymer concentration of about 25 to about 30 weight percent. The resulting polymer solution may, in a further step 16, be spun to form a hollow fiber membrane.

The method 10 may further include a step 18 of stirring the polymer solution for about 4 hours at room temperature prior to the step 16 of spinning the hollow fiber membrane. The method 16 may still further include a step 20 of degassing the polymer solution prior to the step 16 of spinning the hollow fiber membrane.

It should be understood, of course, that the foregoing relates to exemplary embodiments of the invention and that modifications may be made without departing from the spirit and scope of the invention as set forth in the following claims.

We claim:

1. A polymer dope solution comprising:
a solvent;
a non-solvent;
between about 0.5 to about 10 weight percent citric acid admixed in the solvent to give a citric acid solution; and
a polymer dissolved in the citric acid solution, the polymer having a concentration between about 25 and about 30 percent by weight.

2. The polymer dope solution of claim 1, wherein the solvent is selected from the group consisting of N-methylpyrrolidone, dimethyl acetamide, N,N-dimethylformamide, and l-formylpiperidine.

3. The polymer dope solution of claim 1, wherein the solvent is N-methylpyrrolidone.

4. The polymer dope solution of claim 1, wherein the non-solvent is selected from the group consisting of acetone, methanol, ethanol, n-propanol, isopropanol and n-butanol.

5. The polymer dope solution of claim 1, wherein the non-solvent is isopropanol.

6. The polymer dope solution of claim 1, wherein the solvent is present in the citric acid solution at a concentration between about 70 and about 80 weight percent.

7. The polymer dope solution of claim 1, wherein the non-solvent is present in the citric acid solution at a concentration between about 15 and about 25 weight percent.

8. The polymer dope solution of claim 1, wherein the citric acid is present in the citric acid solution at a concentration between about 4 and about 8 weight percent.

9. The polymer dope solution of claim 1, wherein the polymer is selected from the group consisting of polysulfones, poly(ether sulfones), polyimides, polycarbonates, polyphenyl ethers, polyethers, aromatic polyamides, polycarbonates, polysilicones, polyetherimides, polyestercarbonates, copolymers incorporating these polymer types, and mixtures thereof.

10. The polymer dope solution of claim 1, wherein the polymer is a polyimide.

11. The polymer dope solution of claim 10, wherein the polyimide is polymer “A”.

12. A hollow fiber membrane formed by solution spinning a polymer dope solution, the polymer dope solution including a solvent, a non-solvent, between about 0.5 to about 10 weight percent citric acid, and a polymer.

13. The hollow fiber membrane of claim 12, wherein the solvent is N-methylpyrrolidone and the non-solvent is isopropanol.

14. The hollow fiber membrane of claim 12, wherein:
the solvent is present at a concentration between about 70 to about 80 weight percent;
the non-solvent is present at a concentration between about 15 to about 25 weight percent; and
the citric acid is present at a concentration between about 4 to about 8 weight percent.

15. A method for preparing a hollow fiber membrane, the method comprising:
adding citric acid to a solvent to form a citric acid solution;
adding the citric acid solution to a polymer to give a polymer solution having a final polymer concentration of about 25 to about 30 weight percent; and
spinning the polymer solution in a water bath to form a hollow fiber membrane.

16. The method of claim 15, further comprising stirring the polymer solution for about 4 hours at room temperature prior to spinning the hollow fiber membrane.

17. The method of claim 15, further comprising degassing the polymer solution prior to spinning the hollow fiber membrane.

18. The method of claim 15, wherein the solvent is N-methylpyrrolidone and the citric acid is present from about 4 to about 10 weight percent of the resulting citric acid solution.
